(19) United States
(12) Patent Application Publication
(10) Pub. No.: US 2006/0083954 A1
(43) Pub. Date: Apr. 20, 2006

(54) Magnetic recording medium

(75) Inventors: Katsuhiko Meguro, Kanagawa (JP); Masatoshi Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/249,490

(22) Filed: Oct. 14, 2005

(30) Foreign Application Priority Data
Oct. 15, 2004 (JP) P.2004-301500

(51) Int. Cl. G11B 5/706

(52) U.S. Cl. 428/847; 428/842.8; 428/847.3

(57) ABSTRACT

A magnetic recording medium comprising a non-magnetic support and at least one magnetic layer containing a ferromagnetic powder and a binder, wherein the non-magnetic support has an intrinsic viscosity of from 0.46 to 0.58 dl/g and a refractive index in a direction of a depth within a range from 1.490 to 1.500.

### FIELD OF THE INVENTION

The present invention concerns a magnetic recording medium, particularly, for use in flexible disks having a magnetic layer containing a ferromagnetic powder and a binder on a non-magnetic support and, more specifically, it relates to a magnetic recording medium excellent in the punching property upon manufacture of flexible disks, causing resulting obstacles from end faces of the non-magnetic support, being suppressed from dropping out and having excellent electromagnetic conversion characteristic and reliability.

### BACKGROUND OF THE INVENTION

In the field of magnetic recording, practical use of digital recording with less degradation of recording has now been under development from existent analog recording. For recording/reproducing apparatus and magnetic recording media used for digital recording, it has been demanded high image quality, high sound quality, as well as size reduction and space saving. However, since recording for more signals is generally required in the digital recording than in the analog recording, recording at higher density is required for the digital recording.

In recent years, a reading head based on the operation principle of magnetoresistivity (MR) has been proposed, which has been started for use in hard disks, etc., and application to magnetic tapes has been proposed in JP-A-8-227517. In the MR head a read output several times as high as the induction type magnetic head is obtained and equipment noises such as impedance noises are greatly lowered since induction coils are not used, and high SN ratio can be obtained by lowering noises of the magnetic recording medium. In other words, favorable writing and reading can be conducted to outstandingly improve the high density recording characteristic providing that magnetic recording medium noises hidden so far behind equipment noises are decreased.

Heretofore, a magnetic recording medium formed by coating, on a support, a magnetic layer in which iron oxide, Co modified iron oxide, CrO₂, ferromagnetic metal powder, or hexagonal ferrite powder is dispersed in a binder has been used generally. While various means may be considered for decreasing noises, it is particularly effective to decrease the size of ferromagnetic powder particles and a ferromagnetic hexagonal ferrite powder with an average tabular diameter of 40 nm or less has been used to provide an improved effect in recent magnetic materials.

Further, for attaining the high density recording, shortening of wavelength for recording signals or narrowing the track width for recording trace is necessary. For this purpose, refinement of particles for the ferromagnetic powder, higher packing density, and super-smoothing for the surface of magnetic layer have been demanded.

However, it has been known that contaminants are accumulated on a head to cause dropping out even how the surface of the magnetic layer is smoothed. This is because end faces of a non-magnetic support formed by punching, for example, upon manufacture of a flexible disk are scraped in a cartridge to result in obstacles, which are accumulated on the head.

By the way, JP-A-8-45060 describes a magnetic tape having a support comprising a polyethylene naphthalate of a thickness of 4 μm or more, in which the ratio of Young's modulus in the longitudinal direction relative to the Young's modulus in the lateral direction is 0.4 or more and 1.5 or less and the viscosity is 0.45 or more and 0.53 or less, with an aim of preventing failure in a pancake shape by preventing raise of ends (high edge) caused in a slitting step. The unit for the viscosity and measuring method therefore are not disclosed at all.

Further, Japanese Patent No. 3306088 discloses a magnetic recording medium at high density for use in floppy disks using a biaxially oriented polyethylene-2, 6-naphthalate film as a non-magnetic substrate, in which the height and the number of protrusions on the surface of the film, relation for a plane orientation coefficient and an average refractive index, and Young's modular, heat shrinkage ratio, temperature expansion coefficient, etc. of the film.

However, such prior arts do not solve the problem of dropping out caused by obstacles formed from the end faces of the non-magnetic support.

### SUMMARY OF THE INVENTION

The present invention has been achieved in view of the subject as described above, and intends to provide a magnetic recording medium, particularly, for use in flexible disks having a magnetic layer containing a ferromagnetic powder and a binder on a non-magnetic support and, more specifically, it relates to a magnetic recording medium excellent in the punching property upon manufacture of flexible disks, less resulting obstacles from end faces of the non-magnetic support, being suppressed from dropping out and having excellent electromagnetic conversion characteristic and reliability.

Means for solving the subject is as described below.

1) A magnetic recording medium comprising at least one magnetic layer containing a ferromagnetic powder and a binder and a non-magnetic support, in which the non-magnetic support has an intrinsic viscosity of from 0.46 to 0.58 dl/g and a refractive index in the direction of the depth within a range from 1.490 to 1.500.

2) A magnetic recording medium described in 1) above, wherein the ferromagnetic powder is a ferromagnetic hexagonal ferrite powder with an average tabular diameter of from 5 to 40 nm.

According to the invention, since the physical property of the non-magnetic support, that is, the intrinsic viscosity and the refractive index in the direction of the depth (the direction perpendicular to the surface of the support (the thickness direction of the support)) are controlled, it can provide a magnetic recording medium, particularly, excellent in the punching property upon manufacture of flexible disks, less resulting obstacles from the end faces of the non-magnetic support, being suppressed from dropping out and having excellent electromagnetic conversion characteristic and reliability.

### DETAILED DESCRIPTION OF THE INVENTION

The present invention is to be described more specifically.

In the invention, the intrinsic viscosity of the non-magnetic support is from 0.46 to 0.58 dl/g, preferably, from 0.47 to 0.57 dl/g and, more preferably, from 0.48 to 0.56 dl/g. By defining the intrinsic viscosity within the range described above, it is possible to ensure the strength of the non-magnetic support, ensure the film forming property in the stretching step, as well as maintain a dimensional stability of the magnetic recording medium at high temperature and high humidity, and ensure the punching property in the punching step.

In a case where the intrinsic viscosity is less than 0.46 dl/g or exceeds 0.58 dl/g, the punching property is deteriorated, end faces of the non-magnetic support are scraped in a cartridge to result in obstacles and cause dropping out to worsen the electromagnetic conversion characteristic. Further, since the durability is also worsened, no reliability can be provided.

The intrinsic viscosity can be adjusted by properly changing synthesis conditions for the polymer as a starting material of the non-magnetic support, which are not limited particularly but can be adjusted, for example, by controlling the reaction time, reaction temperature, reaction solvent, pressure, concentration of the starting monomer, catalyst, etc. upon polymerization of the starting monomer. Further, this includes sampling of a reaction solution along with the progress of the reaction during synthesis and measuring the viscosity and stopping the reaction at the instance a desired viscosity is reached. Further, this also includes, for example, a method of previously examining the correspondence between the intrinsic viscosity and the torque exerting on a stirrer of a polymerization vessel, and stopping the polymerizing reaction at the instance a predetermined torque is reached. Further, in a case of polycondensation reaction such as for polyether, it can adopt also a method of previously examining the correspondence between the intrinsic viscosity and the amount of water (in direct polymerization) or alcohol (in ester exchange reaction) discharged out of the system during polymerization and stopping the reaction at a stage where a predetermined amount of water or alcohol has been discharged. Further, it can also adopt a method of once conducting polymerization up to an intrinsic viscosity exceeding a predetermined range, and controlling the staying time of the polymer in an extruder before melting and/or after melting such that the melt viscosity is within a predetermined range by previously examining the correspondence between the intrinsic viscosity and the melt viscosity upon film formation.

The intrinsic viscosity referred to in the invention means an intrinsic viscosity of the entire polymer constituting the non-magnetic support, and means a viscosity obtained by plotting, on the abscissa, a concentration when a non-magnetic support (excluding insoluble solids such as powder) is dissolved in a mixed solvent of phenol/1,1,2,2-tetrachloro ethane (60/40: mass ratio (weight ratio)) and plotting, on the ordinate, a relative viscosity corresponding to the solution obtained by measurement using an Ubbelohde viscometer at 25° C., and extrapolating a point for concentration of 0.

Further, it is necessary that the non-magnetic support in the invention has a refractive index in the direction of the depth within a range from 1.490 to 1.500. It is, preferably, from 1.491 to 1.499 and, more preferably, from 1.492 to 1.498. The refractive index of the non-magnetic support is a measure for the orientation of molecules having a great effect on the punching property. In a case where the refractive index is less than 1.490 or exceeds 1.500, the punching property is degraded, the end faces of the non-magnetic support are scraped in a cartridge to result in obstacles thereby causing dropping out and worsening the electromagnetic conversion characteristic.

The refractive index can be controlled, for example, by properly selecting the stretching conditions as will be described below.

In a case of providing magnetic layers on both surfaces of the non-magnetic support, it is necessary that the refractive index of both surfaces can satisfy the range specified above.

The refractive index referred to in the invention means a value measured at 25° C. by an Abbe's refractometer, using the sodium D line (589 nm) as a light source, and using methylene iodide containing sulfur dissolved therein as a mount solution.

Further, in the invention, the Young's modulus both in the longitudinal direction (MD) and the traverse direction (TD) of the non-magnetic support is from 6.0 to 9.0 GPa and, preferably, from 6.2 to 8.8 GPa.

The punting property is further improved by defining the Young's modulus in the longitudinal direction and the traverse direction within the range described above.

In the invention, the Young's modulus of the non-magnetic support is a value measured in accordance with the method specified in JIS K 7113 (1995), by cutting the non-magnetic support to 100 mm length and 5 mm width as a specimen and at a tensile speed of 100 mm/min under a circumstance at 25° C. and 50% RH. For MD and TD of the non-magnetic support, the longitudinal direction of streaks and flaws on the surface of the magnetic layer occurring upon coating or calendering which are observed by using, for example, a differential interference microscope is defined as MD of the non-magnetic support, and the direction perpendicular thereto is defined as TD of the non-magnetic support. In a case of measuring the Young's modulus along MD, a specimen is cut such that the longitudinal direction of the specimen length is in parallel with the longitudinal direction of the non-magnetic support and, in a case of measuring the Young's modulus or the fracture strength in the traverse direction (TD), the specimen is cut such that the longitudinal direction of the specimen length is in parallel with the traverse direction of the non-magnetic support. In a case where a specimen consisting only of the non-magnetic support to be served for measurement can not be obtained, a non-magnetic support obtained by peeling a layer from the magnetic recording medium may also be used.

Further, for the non-magnetic support in the invention, a stylus type, three-dimensional mean surface roughness SRa at the surface of the magnetic layer is, preferably, from 1.0 to 8.0 nm and, more preferably, from 1.5 to 6.0 nm. By defining SRa within the range, the running durability can be ensured and the output can be kept high when it is used as a magnetic recording medium.

In the invention, SRa means a value measured by using a stylus type, three-dimensional mean surface roughness instrument according to JIS B 0601 (1994).

The non-magnetic support used in the invention includes, for example, biaxially stretched polyethylene naphthalate, polyethylene terephthalate, polyamide, polyimide, polyamideimide, aromatic polyamide, and polybenzoxazole. Preferably, a polyester comprising a dicarboxylic acid and a diol such as polyethylene terephthalate or polyethylene naphthalate can be included.

The dicarboxylic acid ingredient as the main constituent ingredient includes, for example, terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenyl thioether dicarboxylic acid, diphenyl ketone dicarboxylic acid, and phenyl indane dicarboxylic acid.

Further, the diol ingredient includes, for example, ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxypnenyl)sulfone, bisphenolfluorene dihydroxyethyl ether, diethylene glycol, neopentyl glycol, hydroquinone, and cyclohexane diol.

Among the polyesters comprising them as the main constituent ingredient, polyesters comprising, as the main constituent ingredient, terephthalic acid and/or 2,6-naphthalene dicarboxylic acid as the dicarboxylic acid ingredient and ethylene glycol and/or 1,4-cyclohexane dimethanol as the diol ingredient are preferred in view of transparency, mechanical strength and dimensional stability.

Among them, polyesters comprising polyethylene terephathalate or polyethylene-2,6-naphthalate as the main constituent ingredient, copolyesters comprising terephthalic acid and 2,6-naphthalene dicarboxylic acid and ethylene glycol, and polyesters comprising a mixture of two or more of such polyesters as the main constituent ingredient are preferred. Particularly preferred are polyesters comprising polyethylene-2,6-naphthalate as the main constituent ingredient.

The polyester constituting the biaxially stretched polyester film used for the non-magnetic support may be further copolymerized with other copolymerizable ingredient or mixed with other polyester so long as it is within the range not deteriorating the effect of the invention. Examples of them include the dicarboxylic acid ingredient and the diol ingredient described above, or polyesters comprising them.

The polyester used for the non-magnetic support may be copolymerized with an aromatic dicarboxylic acid having a sulfonate group or an ester forming derivative thereof, a dicarboxylic acid having a polyoxyalkylene group or an ester forming derivative thereof, or a diol having a polyoxyalkylene group in order to suppress occurrence of delamination during film fabrication.

Among them, preferred are 5-sodium sulfoisophthalic acid, 2-sodium sulfoterephthalic acid, 4-sodium sulfophthalic acid, 4-sodium sulfo-2,6-naphthalene dicarboxylic acid, and a compound formed by substituting sodium therein with other metal (for example, potassium or lithium), ammonium salt and phosphonium salt, or ester forming derivative thereof, polyethylene glycol, polytetramethylene glycol, polyethylene glycol—polypropylene glycol copolymer, and those compounds in which hydroxy groups on both terminals are formed into carboxyl groups, for example, by oxidation. The ratio of copolymerization for this purpose is preferably, from 0.1 to 10 mol % based on the dicarboxylic acid constituting the polyester.

Further, with an aim of improving the heat resistance, a bisphenol compound or a compound having a naphthalene ring or a cyclohexane ring can be copolymerized. The copolymerization ratio of them is preferably from 1 to 20 mol % based on the dicarboxylic acid constituting the polyester.

Further, the method of synthesizing the polyester to be used for the non-magnetic support is not particularly limited and it can be produced in accordance with the known method of producing polyesters. For example, a direct esterifying method of putting a dicarboxylic acid ingredient and a diol ingredient to a direct esterifying reaction, or a ester exchanging method of using a dialkyl ester as a dicarboxylic acid ingredient at first, conducting ester exchange reaction between the same and the diol ingredient, heating them under a reduced pressure and removing excess diol ingredient, to conduct polymerization can be used. In this case, an ester exchanging catalyst or polymerizing reaction catalyst can be used or a heat resistant stabilizer can be added optionally.

Further, one or more of various additives such as coloration inhibitor, antioxidant, nucleating agent, slipping agent, stabilizer, blocking inhibitor, UV-absorbent, viscosity controller, defoaming clarifying agent, antistatic agent, pH controller, dye, and pigment may also be added.

The polyester film used for the non-magnetic support desirably contains fine particles with an average grain size of from 30 to 150 nm, preferably, from 40 to 120 nm by 0.3 mass % (weight %) or less, preferably, 0.2 mass % or less. The fine particles are desirably incorporated with a view point of the durability of the magnetic layer.

As the fine particles, silica, calcium carbonate, alumina, polyacryl particles, and polystyrene particles are preferably used.

The polyester film used for the non-magnetic support can be prepared in accordance with a known method. For example, after extruding a polyester by using a known extruder from the inside of a die at a temperature of a melting point from (Tm) to Tm+70° C. into a sheet, it is quenched and solidified at 40 to 90° C. to obtain an unstretched laminate film. Then, the unstretched film is stretched in accordance with a customary method mono-axially at a temperature near (glass transition temperature (Tg) −10) to (Tg+70)° C. at a factor from 2.0 to 5.0, preferably, at a factor from 2.5 to 4.5, then stretched in the direction orthogonal to the direction described above at a temperature near Tg to (Tg +70)° C. at a factor of 2.0 to 5.0, preferably, at a factor of 2.5 to 4.5 and, further, optionally stretched again in the longitudinal direction and/or traverse direction to obtain a biaxially oriented film. That is, two step, three step, four step or multi step stretching may preferably be conducted. The entire stretching factor is usually three times or more, preferably, 4 to 25 times, more preferably, 4 to 25 times and, further preferably, 4.5 to 20 times as the area stretching factor. Successively, the biaxially oriented film is heat set and crystallized at a temperature from (Tg +70) to (Tm−10)° C., for example, at 180 to 250° C. thereby providing excellent dimensional stability. The heat setting time is preferably from 1 to 60 sec. In the heat setting treatment, it is preferred to control the heat shrinkage ratio by slacking at a ratio of 3.0% or less and, further, from 0.5 to 2.0% in the longitudinal direction and/or traverse direction.

Then, the layer constitution of the magnetic recording medium according to the invention is to be described. While the layer constitution of the magnetic recording medium of the invention is not particularly restricted, and a non-magnetic layer may be provided, for example, between the non-magnetic support and the magnetic layer. Further, in the magnetic recording medium of the invention, a lubricant coating film or various coating films for protecting the magnetic layer may optionally be provided on the magnetic layer. Further, an undercoat layer (easy adhesion layer) may also be provided between the non-magnetic support and the magnetic layer or the non-magnetic layer with an aim of improving the adhesion between the coating film and the non-magnetic support.

The constituent elements of the magnetic recording medium of the invention are to be described more specifically.

[Magnetic layer]

[Ferromagnetic Metal Powder]

There is no particular restriction for the ferromagnetic metal powder used for the magnetic layer in the magnetic recording medium according to the invention, so long as it comprises Fe (including alloy) as the main ingredient, and a ferromagnetic alloy powder comprising α-Fe as the main ingredient is preferred. In addition to the predetermined atom, the ferromagnetic powder may also contain, for example, Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, and B. Those containing at least one of Al, Si, Ca, Y, Ba, La, Nd, Co, Ni, and B in addition to α-Fe are preferred and, particularly, those containing Co, Al, and Y are preferred. More specifically, those containing Co by 10 to 40 at %, Al by 2 to 20 at % and Y by 1 to 15 at % based on Fe are preferred.

The ferromagnetic metal powder may be previously treated before dispersion with dispersant, lubricant, surfactant and antistatic agent to be described later. The ferromagnetic metal powder may also contain a small amount of water, hydroxide or oxide. The water content of the ferromagnetic metal powder is preferably from 0.1 to 2%. The content of the ferromagnetic metal powder is preferably optimized depending on the kind of the binder. pH of the ferromagnetic metal powder is preferably optimized by the combination with the binder to be used. The range is usually from 6 to 12 and, preferably, from 7 to 11. The ferromagnetic powder may sometimes contain inorganic ions such as of soluble Na, Ca, Fe, Ni, Sr, NH₄, SO₄, Cl, NO₂, and NO₃. It is preferred that they are not present substantially. So long as the total for each of the ions is about 300 ppm or less, they give no effect on the characteristic. Further, in the ferromagnetic powder used for the invention, it is preferred that voids are less present, and the value is 20 volume % or less, more preferably, 5% by volume or less.

The crystallite size of the ferromagnetic metal powder is, preferably, from 8 to 20 nm, more preferably, from 10 to 18 nm and, particularly preferably, from 12 to 16 nm. The crystallite size is an average value determined by using an X-ray diffraction apparatus (RINT 2000 series manufactured by Rigaku Denki) in accordance with a Scherrer method based on the half-value width of a diffraction peek under the condition of using CuKαI as a source and at a tube voltage of 50 kV and a tube current of 300 mA.

The specific surface area of the non-magnetic metal powder according to the BET method (S_{BET}) is, preferably, 30 m²/g or more and less than 50 m²/g and, more preferably, from 38 to 48 m²/g. Within the range described above, it is possible to compatibilize favorable surface property and low noise. pH of the ferromagnetic metal powder is preferably optimized by the combination with the binder to be used. The range is from 4 to 12 and, preferably, from 7 to 10. The ferromagnetic metal powder may optionally be applied with a surface treatment by Al, Si, P or an oxide thereof. The amount is from 0.1 to 10% based on the ferromagnetic metal powder and the application of the surface treatment is preferred since the adsorption of a lubricant such as a fatty acid is decreased to 100 mg/m² or less. While the ferromagnetic metal powder may sometimes contain inorganic ions such as soluble Na, Ca, Fe, Ni, and Sr, they give less effect on the characteristic at 200 ppm or less. Further, it is preferred that voids are less contained in the ferromagnetic metal powder used in the invention and the value is 20% by volume or less and, more preferably, 5% by volume or less.

Further, as the shape of the ferromagnetic metal powder the average major axis length is from 20 to 100 nm, preferably, from 30 to 90 nm and, more preferably, from 40 to 80 nm. Further, while the shape of the ferromagnetic metal powder may be any of acicular, granular, grainy or platy shape, use of an acicular ferromagnetic powder is preferred. In the case of the acicular ferromagnetic metal powder, the tabular ratio is, preferably, from 4 to 12 and, more preferably, from 5 to 12. The coercive force (Hc) of the ferromagnetic metal powder, is preferably, from 159.2 to 238.8 kA/m (2000 to 3000 Oe) and, more preferably, from 167.2 to 230.8 kA/m (2100 to 2900 Oe). Further, the saturation magnetic flax density is preferably from 150 to 300 mT (1500 to 3000 G) and, more preferably, from 160 to 290 mT. Further, the saturation magnetization (σs) is, preferably, from 140 to 170 A·m²/kg (140 to 170 emu/g) and, more preferably, from 145 to 160 A·m²/kg. SFD (switching field distribution) of the magnetic body itself is preferably smaller and, it is preferably 0.8 or less. In a case where SFD is 0.8 or less, the electromagnetic conversion characteristic is favorable, the output is high and the magnetization reversal is sharp with the peek shift being decreased, which is suitable to high density digital magnetic recording. For narrowing the Hc distribution, there is a method, for example, of improving the grain distribution of the geothite, using mono-dispersed α-Fe₂O₃, or preventing sintering between the particles in the ferromagnetic metal powder.

For the ferromagnetic metal powder, those obtained by known manufacturing methods can be used and they include the following methods. They are a method of reducing hydrous iron oxide and iron oxide subjected to a sintering-preventive treatment with a reducing gas such as hydrogen to obtain Fe or Fe—Co particles, a method of reducing a composite organic acid salt (mainly oxalate) and a reducing gas such as hydrogen, a method of thermally decomposing metal carbonyl compound, a method of reducing by adding a reducing agent such as sodium borohydride, hypophosphate or hydrazine to an aqueous solution of a ferromagnetic metal, and a method of evaporating a metal in an inert gas at a low pressure to obtain a powder. A known gradual oxidation treatment is applied to the thus obtained ferromagnetic metal powder. The method of reducing hydrous iron oxide or iron oxide with a reducing gas such as hydrogen and forming an oxide film on the surface by controlling the partial pressure of an oxygen containing gas and an inert gas, temperature, and the time is preferred since the demagnetization amount is small.

[Ferromagnetic Hexagonal Ferrite Powder]

The ferromagnetic hexagonal ferrite powder includes, for example, barium ferrite, strontium ferrite, lead ferrite, calcium ferrite and Co substitutes thereof, more specifically, they include magnetoplumbite type barium ferrite and strontium ferrite, magnetoplumbite type ferrite coated with spinel at the surface of particles, and magnetic plane bite type barium ferrite and strontium ferrite containing a spinel phase to a portion thereof. In addition to predetermined atoms, those atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb may also be contained. Generally, those with addition of elements such as Co—Zn, Co—Ti, Co—Ti—Zr, Co—Ti—Zn, Ni—Ti—Zn, Nb—Zn—Co, Sb—Zn—Co, and Nb—Zn can be used. Further, depending on the row material and manufacturing method, they may sometimes contain inherent impurities.

For the grain size of the ferromagnetic hexagonal ferrite powder, an average tabular diameter is from 5 to 40 nm, preferably, from 10 to 38 nm and, more preferably, from 15 to 36 nm as described above.

By defining the average tabular diameter to 5 to 40 nm, noises of the magnetic recording medium are reduced and a large Sn ratio can be obtained.

Further, the average tabular thickness is from 1 to 30 nm, preferably, from 2 to 25 nm and, more preferably, from 3 to 20 nm. The average tabular ratio {average for (tabular diameter/tabular thickness)} is from 1 to 15 and, more preferably, from 1 to 7. In a case where the average tabular ratio is from 1 to 15, a sufficient orientation property can be obtain while maintaining high packing density in the magnetic layer and the increase of noises can be suppressed by stacking between particles. Further, the specific surface area within the range of the grain size according to the BET method is from 10 to 200 m²/g. The specific surface area generally corresponds to the calculated value based on the tabular diameter and the tabular thickness of the particle.

Usually, narrower distribution for the tabular diameter-tabular thickness of the particle of the ferromagnetic hexagonal ferrite is preferred. Digitalization of the tabular diameter-tabular thickness of the particle can be compared by measuring particles by the number of 500 at random from a particle TEM photograph. Often, distribution for the tabular diameter·tabular thickness of the particle is not in a normal distribution, σ/average size=0.1 to 2.0 when calculated and expressed by standard deviation to the average size. For making the particle size distribution sharp, it is also conducted to make the particle forming reaction system as uniform as possible and apply a distribution improving treatment to formed particles. For example, a method of selectively dissolving super micro particles in an acid solution is also known.

The coercive force (Hc) of the hexagonal ferrite particle can be within a range from 159.2 to 238.8 kA/m (2000 to 3000 Oe), preferably, from 175.1 to 222.9 kA/m (2200 to 2800 Oe) and, more preferably, from 183.1 to 214.9 kA/m (2300 to 2700 Oe). In a case where the saturation magnetization (σs) exceed 1.4 T, it is preferably 159.2 kA/m or less. The coercive force (Hc) can be controlled depending on the grain size (tabular diameter-tabular thickness) kind and the amount of incorporated element, the substitution site for element and grain forming reaction condition, etc.

The saturation magnetization (σs) of the hexagonal ferrite particle is from 40 to 80 A·m²/kg (emu/g). While higher saturation magnetization (σs) is preferred, it tends to be smaller as the particle is finer. For the improvement of the saturation magnetization (σs), it has been well known, for example, to composite spinel ferrite with magnetoplumbite ferrite or selection for the kind and the addition amount of the element contained. Further, W-type hexagonal ferrite can also be used. In a case of dispersing the magnetic material, it is also conducted to treat the surface of the magnetic particles with a material suitable to the dispersion medium or the polymer. As the surface treating agent, inorganic compounds and organic compounds are used. As main compound, oxides or hydroxides of Si, Al, P, etc., various kinds of silan coupling agents, and various kinds of titanium coupling agents are typical examples. The addition amount is from 0.1 to 10 mass % based on the mass of the magnetic material. pH of the magnetic material is also important for dispersion. It is usually about 4 to 12 and, while the optimal value is determined depending on the dispersion medium or the polymer, it is selected to about 6 to 11 in view of the chemical stability and the storability of the medium. Water contained in the magnetic material also has an effect on the dispersion. While an optimal value is present dependent on the dispersant and the polymer, it is usually selected within range from 0.01 to 2.0%.

The manufacturing method of the ferromagnetic hexagonal ferrite includes, for example, (1) a glass crystallization method of mixing barium oxide, iron oxide, metal oxide substituting iron, boron oxide, as a glass forming material so as to provide a desired ferrite composition, then melting and quenching them into an amorphous form, then applying a re-heating treatment, cleaning and pulverization to obtain a barium ferrite crystal powder, (2) a hydrothermic reaction method of neutralizing a solution of a barium ferrite composition metal salt with an alkali, removing by-products, heating in a liquid phase at 100° C. or higher and them cleaning, drying and pulverizing the same to obtain a barium ferrite crystal powder, and (3) a co-precipitation method of neutralizing the solution of a barium ferrite composition metal salt with an alkali, removing the by-products and then drying and treating at 1100° C. or lower and then pulverizing the same to obtain a barium ferrite crystal powder. However, the invention is not restricted to the manufacturing method. The ferromagnetic hexagonal ferrite powder may be optionally applied with a surface treatment, for example, by Al, Si, P or an oxide thereof. The amount is from 0.1 to 10% based on the ferromagnetic powder and the application of the surface treatment is preferred since the adsorption of the lubricant such as a fatty acid is decreased to 100 mg/m² or less. The ferromagnetic powder may sometimes contain inorganic ions such as of soluble Na, Ca, Fe, Ni, and Sr. While it is preferred that they are not present substantially, they give less particular effect on the characteristic at 200 ppm or less.

<Binder >

The binder used for the magnetic layer of the invention is a known thermoplastic resin, thermosetting resin, reactive resin or mixture thereof. The thermoplastic resin includes, for example, polymers or copolymers containing vinyl chloride, vinyl acetate, vinyl alcohol, maleic acid, acrylic acid, acrylate ester, vinylidene chloride, acrylonitrile, methacrylic acid, methacrylate ester, styrene, butadiene, ethylene, vinyl butyral, vinyl acetal, and vinyl ether as constituent units, polyurethane resins, and various kinds of rubber resins.

Further, the thermosetting resin or the reactive resin includes, for example, a phenol resin, epoxy resin, polyurethane curable resin, urea resin, melamine resin, alkyd resin, acrylic reactive resin, formaldehyde resin, silicone resin, epoxy-polyamide resin, mixture of polyester resin and isocyanate prepolymer, a mixture of polyester polyol and polyisocyanate, and a mixture of polyurethane and polyisocyanate. Details for each of the thermoplastic resins, thermosetting resins and reactive resins are described in “Plastic Handbook” published from Asakura Shoten.

Further, in a case of using an electron beam curable resin for the magnetic layer, not only the coating film strength is improved to enhance the durability but also the surface is smoothed to further improve the electromagnetic conversion characteristic. Such examples and manufacturing methods thereof are specifically described in JP-A No. 62-256219.

The resins described above can be used each alone or in a state of the combination thereof. Among them, use of the polyurethane resin is preferred and, further, it is preferred to use a polyurethane resin formed by reacting a cyclic structural material such as a hydrogenated bisphenol A or a polypropylene oxide adduct of hydrogenated bisphenol A, a polyol of a molecular weight from 500 to 5,000 having an alkylene oxide chain, a polyol of a molecular weight of 200 to 500 having a cyclic structure as a chain extender, and an organic diisocyanate and introducing a polar group, or a polyurethane resin formed by reacting a polyester polyol comprising an aliphatic dibasic acid such as succinic acid, adipic acid or sebasic acid, an aliphatic diol with no cyclic structure having an alkyl branched side chain such as 2,2-dimethyl-1,3-propanediol, 2-ethyl-2-butyl-1,2-propanediol, or 2,2-diethyl-1,3-propanediol, an aliphatic diol having a branched alkyl side chain of three or more carbon atoms such as 2-ethyl-2-butyl-1,3-propanediol, or 2,2-diethyl-1,3-propanediol comprising an aliphatic diol with no cyclic structure having an alkyl branched side chain and an organic diisocyanate compound, and introducing a polar group, or a polyurethane resin formed by reacting a cyclic structural material such as a dimer diol, a polyol compound having a long alkyl chain, and organic diisocyanate and introducing a polar group.

The average molecular weight of the polar group-containing polyurethane resin used in the invention has an average molecular weight, preferably, from 5,000 to 100,000 and, more preferably, from 10,000 to 50,000. In a case where the average molecular weight is 5,000 or more, it is preferred since this results in no deterioration of the physical strength such as brittleness of the obtained magnetic coating film and gives no undesired effects on the durability of the magnetic recording medium. Further, in a case where the molecular weight is 100,000 or less, since this does not lower the solubility to a solvent, dispersibility is also preferred. Further, since the viscosity of the coating material is not increased at a predetermined concentration, the working property is favorable and handling is also easy.

The polar group contained in the polyurethane resin includes, for example, —COOM, —SO₃M, —OSO₃M, —P═O(OM)₂, —O—P═O(OM)₂ (M represents hydrogen atom or alkali metal salt in the formula described above), —OH, NR₂, N⁺R₃ (R represents hydrocarbon group), epoxy group, —SH, or —CN. Those in which at least one of the polar groups are introduced by copolymerization or addition reaction can be used. In a case where the polar group-containing polyurethane resin has an OH group, it is preferred to have a branched OH group in view of the curability and the durability and it is preferred to have a branched OH groups by the number from 2 to 40 per one molecule and, more preferably, from 3 to 20 per one molecule. Further, a preferred amount of the polar group is from 10⁻¹ to 10⁻⁸ mol/g and, more preferably, from 10⁻² to 10⁻⁶ mol/g.

Specific examples of the binder include, for example, VAGH, VYHH, VMCH, VAGF, VAGD, VROH, VYES, VYNC, VMCC, XYHL, XYSG, PKHH, PKHJ, PKHC and PKFE manufactured by Union Carbide Co., MPR-TA, MPR-TA5, MPR-TAL, MPR-TSN, MPR-TMF, MPR-TS, MPR-TM, and MPR-TAO manufactured by Nissin Chemical Industry Co.,

1000W, DX80, DX81, DX82, DX83, and 100FD manufactured by Denki Kagaku Co., MR-104, MR-105, MR110, MR100, MR555, and 400X-110A manufactured by Nippon Zeon Co., NIPPOLAN N2301, N2302, and N2304 manufactured by Nippon Polyurethane Co., PANDEX T-5105, T-3080, T-5201, BARNOCK D-400, D-210-80, CRYSBORN 6109, 7209 manufactured by Dai Nippon Ink Co., VYLON UR8200, UR8300, UR-8700, RV530, RV280, manufactured by Toyobo Co., DAIFERAMINE 4020, 5020, 5100, 5300, 9020, 9022, and 7020 manufactured by Dainichi Seika Co., MX5004 manufactured by Mitsubishi Kasei Co., SANPRENE SP-150 manufactured by Sanyo Kasei Co., and SARAN F310, F210 manufactured by Asahi Kasei Co.

The addition amount of the binder used for the magnetic layer of the invention is within a range from 5 to 50 mass % and, preferably, within a range from 10 to 30 mass % based on the mass of the ferromagnetic powder. In a case of using the polyurethane resin, it is preferably used by 2 to 20 mass % in combination with the polyisocyanate within a range from 2 to 20 mass %. For example, in a case where head corrosion occurs by slight amount of dechlorination, it is possible to use only the polyurethane or only the polyurethane and the polyisocyanate. In a case of using the vinyl chloride resin as other resins, it is preferably within a range from 5 to 30 mass %. In the invention, in a case of using the polyurethane, the glass transition temperature is from −50 to 150° C. and, preferably, from 0 to 100° C., the elongation at break is from 100 to 2,000%, fracture stress is from 0.49 to 98 MPa (0.05 to 10 kg/mm²), and the yielding point is from 0.49 to 98 MPa (0.05 to 10 kg/mm²).

The magnetic recording medium used in the invention can be constituted with two or more layers on the non-magnetic support. Accordingly, it is of course possible to optionally change the amount of the binder, the amount of the vinyl chloride resin, polyurethane resin, polyisocyanate or other resins in the binder, the molecular weight, the amount of polar groups that forms the magnetic layer, or the physical characteristic of the resin described previously for the non-magnetic layer and each of the magnetic layers, and it should be rather optimized in each of the layers and known technique regarding the multi-layered magnetic layer can be applied. For example, in a case of changing the amount of the binder in each of the layers, it is effective to increase the amount of the binder in the magnetic layer for decreasing the scratch injury on the surface of the magnetic layer and the amount of the binder in the non-magnetic layer may be increased to provide flexibility in order to improve the head touch to the head.

The polyisocyanate usable in the invention includes, for example, isocyanates such as tolylene diisocyanate, 4,4′-diphenyl methane diisocyanate, hexamethylene diisocyanate, xylylene diisocyanate, naphthylene-1,5-diisocyanate, o-toluidine diisocyanate, isophorone diisocyanate, triphenyl methane triisocyanate, and, further, products of the isocyanates described above and polyalcohols, or polyisocyanates formed by condensation of isocyanates. Name of products commercially available for the isocyanates includes CORONATE L, CORONATE-HL., CORONATE 2030, CORONATE 2031, MILLIONATE MR, MILLIONATE MTL, manufactured by Nippon Polyurethane Co., TAKENATE D-102, TAKENATE D-110N, TAKENATE D-200, TAKENATE D-202, manufactured by Takeda Yakuhin Co., and DESMODULE L, DESMODULE IL, DESMODULE N, and DESMODULE HL, manufactured by Sumitomo-Bayer Co. and it is also possible to use them each alone or as a combination of two or more them while utilizing the difference of the curing reactivity for each of the layers.

In the magnetic layer of the invention, additives can be added optionally. The additives include, for example, abrasives, lubricants, dispersions, dispersion aids, anti-moulds, antistatics, antioxidants, solvents and carbon blacks. The additives described above usable herein include, for example, molybdenum disulfide, tungsten disulfide, graphite, boron nitride, fluorinated graphite, silicone oil, silicone having polar group, fatty acid modified silicone, fluorine-containing silicone, fluorine-containing alcohol, fluorine-containing ester, polyolefin, polyglycol, polyphenylether, aromatic ring-containing organic phosphonic acids such as phenyl sulfonic acid, benzyl phosphonic acid, phenethyl phosphonic acid, α-methylbenzyl phosphonic, 1-methyl-1-phenethyl phosphoric acid, diphenylmethyl phosphonic acid, biphenyl phosphonic acid, benzylphenyl phosphonic acid, α-cumyl phosphonic acid, toluyl phosphonic acid, xylyl phosphonic acid, ethylphenyl phosphonic acid, cumenyl phosphonic acid, propylphenyl phosphonic acid, butylphenyl phosphonic acid, heptylphenyl phosphonic acid, octylphenyl phosphonic acid, and nonylphenyl phosphonic acid and alkali metal salts thereof, alkyl phosphonic acid such as octyl phosphonic acid, 2-ethylhexyl phosphonic acid, isooctyl phosphonic acid, isononyl phosphonic acid, isodecyl phosphonic acid, isoundecyl phosphonic acid, isdodecyl phosphonic acid, isohexadecyl phosphonic acid, isooctadecyl phosphonic acid, and isoeicocyl phosphonic acid, and alkali metal salts thereof, aromatic phosphate esters such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, nonylphenyl phosphate, and alkali metal salts thereof, alkyl phosphate esters such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicocyl phosphate, and alkali metal salts thereof, alkyl sulfonate esters and alkali metal salts thereof, fluoro-containing alkyl phosphate esters and alkali metal salts thereof, monobasic aliphatic acids of 10 to 24 carbon atoms which may contain unsaturated bonds or which may be branched such as lauric acid, mirystinic acid, palmitic acid, stearic acid, behenic acid, butyl stearate, oleic acid, lanolin acid, linolenic acid, elaidic acid, and erucic acid, and metal salts thereof, or monofatty acid esters, difatty acid ester, or polybasic fatty acid esters comprising a monobasic fatty acid of 10 to 24 carbon atoms which may contain unsaturated bond or which may be branched and one of mono- to hexa-hydric alcohols of 2 to 22 carbon atoms which may contain unsaturated bond or which may be branched, alkoxy alcohols of 12 to 22 carbon atoms which may contain unsaturated bonds or which may be branched, or monoalkyl ethers of alkylene oxide polymers, such as butyl stearate, octyl stearate, amyl stearate, isooctyl stearate, octyl mirystate, butyl laurate, butoxyethyl stearate, anhydrosorbitane monostearate and anhydrosorbitan tristearate, fatty acid amide of 2 to 22 carbon atoms and fatty acid amine of 8 to 22 carbon atoms. In addition to the hydrocarbon groups described above, those having alkyl group, aryl group, or aralkyl group substituted with the group other than the hydrocarbon group such as nitro group F, Cl, Br, or halogen containing hydrocarbon such as CF₃, CCl₃, CBr₃ may also be used.

Further, nonionic surfactants such as alkylene oxide, glycerine, glycidol, alkylphenol ethyleneoxide adduct, cationic surfactants such as cyclic amine, ester amide, quaternary ammonium salts, hydantoin derivatives, heterocyclic rings, phosphonium or sulfoniums, anionic surfactants containing acidic groups such as carboxylic acid, sulfonic acid and phosphate ester group, and amphoteric surfactants such as amino acids, amino sulfonic acids, sulfate or phosphate esters of amino alcohol, and alkyl betains may also be used. Such surfactants are described specifically in “Surfactant Manual” (published from Sangyo Tosho Co.).

The lubricant, antistatic, etc. may not always be pure products but may also contain impurities such as isomers, unreaction products, reaction by-products, decomposition products and oxides in addition to the main ingredients. The impurity is preferably, 30 mass % or less and, more preferably, 10 mass % or less.

Specific examples of the additives include, for example, NAA-102, castor oil hardened fatty acid, NAA-42, cation SA, Nymine L-201, Nonion E-208, Anone BF, Anone LG, manufactured by Nippon Oil and Fats Co., FAL-205, FAL-123, manufactured by Takemoto Oil and Fats Co., Enujelbu OL manufactured by Shin Nippon Rika Co., TA-3, manufactured by Shinetsu Chemical Co. Armide P, manufactured by Lion Armar Co., Duomine TDO, manufactured by Lion Co., BA-41G, manufactured by Nissin Seiyu Co., Profane 2012E, New pole PE61, and Ionet MS-400, manufactured by Sanyo Kasei Co.

Further, for the magnetic layer in the invention, carbon black can be added optionally. The carbon black usable for the magnetic layer includes rubber furnace black, rubber thermal black, color black, acetylene black, etc. It is preferred that the specific surface area is from 5 to 500 m²/g, the DBP oil absorption is from 10 to 400 ml/100 g, the grain size is from 5 to 300 mμ, pH is from 2 to 10, water content is from 0.1 to 10%, and the tap density is from 0.1 to 1 g/ml.

Specific examples of the carbon black used in the invention includes BLACKPEARLS 2000, 1300, 1000, 900, 905, 800, 700, VULCAN XC-72, manufactured by Cabot Co., #80, #60, #55, #50, #35, manufactured by Asahi Carbon Co., #2400B, #2300, #900, #1000, #30, #40, #10B, manufactured by Mitsubishi Kasei Industry Co., CONDUCTEX SC, RAVEN 150, 50, 40, 15, RAVEN-MT-P, manufactured by Colombian Carbon Co., and Ketchen Black EC, manufactured by Nippon EC Co. Carbon black may be used being surface treated by a dispersant or the like, may be used being grafted with a resin or may be used being partially graphitized the surface. Further, the carbon black may be previously dispersed with a binder before addition to the magnetic coating material. The carbon black may be used alone or used in combination. In a case of using the carbon black, it is preferably used by from 0.1 to 30 mass % based on the mass of the magnetic material. The carbon black has functions of preventing charging, reducing the friction coefficient, providing light screening property and improving the film strength of the magnetic layer and they may be different depending on the carbon black to be used. Accordingly, it is of course possible that the carbon black may be used selectively in accordance with the purpose by changing the kind, the amount and the combination between the magnetic layer and the non-magnetic layer and based on various characteristics as described above such as the grain size, oil absorption, electroconductivity, pH, etc. and it should rather be optimized for each of the layers. For the carbon black usable for the magnetic layer in the invention, “Carbon Black Manual” edited by Carbon Black Association, etc. can be referred to.

For the organic solvent used in the invention, known solvents can be used. As the organic solvent used in the invention, ketoses such as acetone, methyl ethyl ketone, methyl isobutyl ketone, dissolutely ketone, cyclohexanone, isophorone, and tetrahydrofuran, alcohols such as methanol, ethanol, propanol, butanol, isobutyl alcohol, isopropyl alcohol, and methyl cyclohexanol, esters such as methyl acetate, butyl acetate, isobutyl acetate, isopropyl acetate, ethyl lactate, and glycol acetate, glycol ethers such as glycol dimethyl ether, glycol monthly ether, and dioxin, aromatic hydrocarbons such as benzene, toluene, xylene, cresol, and chlorobenzene, chlorinated hydrocarbons such as ethylene chloride, ethylene chloride, carbon tetrachloride, chloroform, ethylene chlorohydrine, and dichlorobenzene, N,N-dimethylformamide, and hexane can be used at any ratio.

The organic solvents may not always be 100% pure products but may also contain an impurity such as isomers, unreaction products, side reaction products, decomposition products, oxides, and water in addition to the main ingredient. The impurity is, preferably, 30% or less and, more preferably, 10% or less. It is preferred that the kind of the organic solvent used in the invention is identical for the magnetic layer and the non-magnetic layer. The addition amount may be changed. It is important to use a solvent of high surface tension (cyclohexanone, dioxane, etc.) for the non-magnetic layer to improve the stability of coating, specifically, that the arithmetic average value for the coating composition in the upper layer is not less than the arithmetic average value for the solvent composition for the non-magnetic layer. It is preferred that the polarity is somewhat strong in order to improve the dispersibility, and it is preferred that a solvent with a dielectric constant of 15 or more is contained by 50% or more in the solvent composition. Further, the solubility parameter is preferably from 8 to 11.

The dispersant, the lubricant, and the surfactant used in the invention can be optionally used selectively in view of the kind and the amount thereof for the magnetic layer and the non-magnetic layer to be described later. For example, it is considered that the dispersant has a property of adsorbing or bonding at the polarity group and adsorbs or bonds at the polarity group mainly to the surface of the ferromagnetic metal powder in the magnet's layer, or mainly to the surface of the non-magnetic powder in the non-magnetic layer and, for example, once adsorbed organic phosphoric compound is less desorbed from the surface of metal or metal compound although not restricted only to the example shown here. Accordingly, since the ferromagnetic metal powder surface or the non-magnetic powder surface in the invention shows a state as covered with alkyl groups, aromatic groups, etc., the affinity of the ferromagnetic metal powder or non-magnetic powder to the binder resin ingredient is improved and, further, the dispersion stability of the ferromagnetic metal powder or the non-magnetic powder is also improved. Further, since the lubricant is present in the free state, coating stability is improved by using fatty acids of different melting points for the non-magnetic layer and the magnetic layer to control exudation to the surface, by using esters of different boiling points or polarities to control exudation to the surface, controlling the amount of the surfactant to improve the coating stability, and by increasing the addition amount of the lubricant for the non-magnetic layer to improve the lubrication effect. Further, the additives used in the invention may be added partially or entirely in any of the steps during manufacture of the coating solution for use in the magnetic layer or non-magnetic layer. For example, it includes a case of mixing with the ferromagnetic powder before a kneading step, a case of adding in the kneading step for the ferromagnetic powder, the binder and the solvent, a case of adding in the dispersion step, a case of adding after dispersion, or a case of adding just before coating.

[Non-Magnetic Layer]

Then, details concerning the non-magnetic layer is to be described. The magnetic recording medium according to the invention can have a non-magnetic layer containing a binder and a non-magnetic powder on a non-magnetic support. The non-magnetic powder usable for the non-magnetic layer may be either an inorganic material or an organic material. Further, carbon black or the like may also be used. The inorganic material includes, for example, metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO_{2,} SiO₂, Cr₂O₃, α-alumina at 90 to 100% alpharization ratio, β-alumina, γ-alumina, α-iron oxide, geothite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide and titanium carbide are used each alone or as a mixture of two or more of them in combination. α-iron oxide and titanium oxide are preferred.

The shape of the non-magnetic powder may be any of acicular, spherical, polyhedral or platy shape. The crystallite size of the non-magnetic powder is, preferably, from 4 nm to 1 μm and, more preferably, from 40 to 100 nm. The crystallite size within the range of 4 nm to 1 μm is preferred since this does not make the dispersion difficult and provides a suitable surface roughness. While the average grain size of the non-magnetic powder is preferably from 5 nm to 2 μm, same effects can also be provided by optionally combining non-magnetic powders of different average grain size or extending the grain size distribution for a single kind of non-magnetic powder. A particularly preferred average grain size of the non-magnetic powder is from 10 to 200 nm. This is since a range from 5 nm to 2 μm provides good dispersion and suitable surface roughness.

The specific surface area of the non-magnetic powder is from 1 to 100 m²/g, preferably, from 5 to 70 m²/g and, more preferably, from 10 to 65 m²/g. It is preferred that the specific surface area is within the range from 1 to 100 m²/g since this can provide a suitable surface roughness and the powder can be dispersed by a desired amount of the binder.

The oil absorption amount when using dibutyl phthalate (DBP) is from 5 to 100 ml/100 g, preferably, from 10 to 80 ml/100 g and, more preferably, from 20 to 60 ml/100 g. The specific gravity is from 1 to 12, preferably, from 3 to 6. The tap density is from 0.05 to 2 g/ml, preferably, from 0.2 to 1.5 g/ml. In a case where the tap density is within a range from 0.05 to 2 g/ml, less particles are scattered to facilitate operation and they also less tend to be adhered to the apparatus. The pH of the non-magnetic powder is preferably from 2 to 11 and pH between 6 to 9 particularly preferred. In a case where pH is within the range from 2 to 11, the friction coefficient is not increased under high temperature and high humidity, or liberation of the fatty acid. The water content in the non-magnetic powder is from 0.1 to 5 mass %, preferably, from 0.2 to 3 mass % and, more preferably, from 0.3 to 1.5 mass %. It is preferred that the water content is within the range from 0.1 to 5 mass % since the dispersion is favorable and the viscosity of the coating material after dispersion is also stabilized. The ignition loss is preferably 20 mass % or less and those of less ignition loss are preferred.

Further, in a case where the non-magnetic powder is an inorganic powder, the Mohs hardness is preferably from 4 to 10. In a case where the Mohs hardness is within the range from 4 to 10, the durability can be ensured. The stearic acid absorption amount of the non-magnetic powder is from 1 to 20 μmol/m² and, more preferably, from 2 to 15 μmol/m². The heat of wetting of the non-magnetic powder to water at 25° C. is preferably within a range from 200 to 600 erg/cm² (200 to 600 mJ/m²). Further, a solvent with the heat of wetting within the range described above can be used. The amount of molecules of water on the surface at 100 to 400° C. is appropriately from 1 to 10 N/100 Å. pH for the isoelectric point in water is preferably between 3 and 9. It is preferred that Al₂O₃, SiO₂, TiO₂, ZrO₂, SnO₂, Sb₂O₃ or ZnO is present on the surface of the non-magnetic powder by the application of a surface treatment. For the dispersibility, Al₂O₃, SiO₂, TiO₂ and ZrO₂ are particularly preferred and Al₂O₃, SiO₂, and ZrO₂ are more preferred. They may be used in combination or may be used alone. Further, depending on the purpose, a co-precipitated surface treatment layer may also be used, or a method of at first treating with alumina and then treating the surface layer with silica, or a method opposite thereto may also be adopted. Further, the surface treatment layer may be formed as a porous layer depending on the purpose but it is generally preferred that the layer is homogeneous and dense.

Specific examples of the non-magnetic powder used for the non-magnetic layer in the invention include, for example, NANOTITE, manufactured by Showa Denko Co., HIT-100, and ZA-G1, manufactured by Sumitomo Chemical Co., DPN-250, DPN-250BX, DPN-245, DPN-270BX, DPB-550BX, DPN-550RX, manufactured by Toda Industry Co., titanium oxide TTO-51B, TTO-55A, TTO-55B, TTO-55C, TTO-55S, TTO-55D, SN-100, MJ-7, α-iron oxide, E270, E271, and E300, manufactured by Ishihara Industry Co., STT-4D, STT-30D, STT-30, and STT-65C, manufactured by Titan Industry Co., MT-100S, MT-100T, MT-150W, MT-500B, T-600B, T-100F, and T-500HD manufactured by Teika Co. They also include FINEX-25, BF-1, BF-10. BF-20, and ST-M manufactured by Sakai Chemical Co., DEFIC-Y, DEFIC-R, manufactured by Dowa Kogyo Co., AS2BM and TiO2P25, manufactured by Nippon Aerosil Co., 100A, 500A, manufactured by Ube Kosan Co., and Y-LOP manufactured by Titan Industry Co., and sintered products thereof. Particularly preferred non-magnetic powder are titanium dioxide and α-iron oxide.

A carbon black may be mixed together with the non-magnetic powder in the non-magnetic layer to lower the surface electric resistance, decrease the light permeability and obtain a desired micro Vickers hardness. The micro Vickers hardness of the non-magnetic layer is usually from 25 to 60 kg/mm² (245 to 588 MPa) and, preferably, from 30 to 50 kg/mm² (294 to 490 MPa) for controlling the head abutment and this can be measured by using a thin film hardness gage (HMA-400, manufactured by Nippon Denki) with a triangular pyramidal stylus made of diamond having a ridge angle of 80° and radius at the top end of 0.1 μm being used at the top of an indentor. The light transmittance is generally standarized that the absorption for the infrared rays at a wavelength of about 900 nm is 3% or less, for example, 0.8% or less for a VHS magnetic tape. For this purpose, rubber furnace black, rubber thermal black, color black, acetylene black, etc. can be used.

It is preferred that the carbon black used for the non-magnetic layer in the invention has a specific surface area from 100 to 500 m²/g, preferably, from 150 to 400 m²/g, a DBP oil absorption amount from 20 to 400 ml/100 g and, preferably, from 30 to 200 ml/100 g. The grain size of the carbon black is from 5 to 80 nm, preferably, from 10 to 50 nm and, more preferably, from 10 to 40 nm. pH of the carbon black is from 20, the water content is from 0.1 to 10% and the tap density is from 0.1 to 1 g/ml.

Specific examples of the carbon black usable for the non-magnetic layer in the invention include BLACKPEARLS 2000, 1300, 1000, 900, 800, 880, 700, and VULCAN XC-72, manufactured by Cabot Co., #3050B, #3150B, #3250B, #3750B, #3950B, #950, #650B, #970B, #850B, MA-600, manufactured by Mitsubishi Kasei Industry Co., CONDUCTEX SC, RAVEN 8800, 8000, 7000, 5750, 5250, 3500, 2100, 2000, 1800, 1500, 1255, 1250, manufactured by Columbia Carbon Co., and Ketchen Black EC, manufactured by Akuzo Co.

Further, the carbon black may be used by being a surface treated, for example, with a dispersant, or being grafted with a resin, or being partially graphatized at a portion of the surface. Before adding the carbon black to the coating material, it may previously be dispersed with a binder. The carbon black can be used within a range not exceeding 50 mass % based on the inorganic powder and within a range not exceeding 40% for the total mass of the non-magnetic layer. For the carbon black can be used each alone or used in combination. For the carbon black usable for the non-magnetic layer in the invention, “Carbon Black Manual” edited by Carbon Black Society, etc., can be referred to.

Further, an organic powder may also be added depending on the purpose to the non-magnetic layer and such organic powder includes, for example, acryl-styrene resin powder, benzoguanamine resin powder, melamine resin powder, and phthalocyanine pigment, and polyolefin resin powder, polyester resin powder, polyamide resin powder, and polytetrafluoroethylene can also be used. As the manufacturing methods, those described in JP-A-62-18564 and JP-A-60-255827 can be used.

As the binder resin, lubricant, dispersant, additives, solvent, dispersion method and the like for the non-magnetic layer, those for the magnetic layer are applicable. Particularly, for the amount and the kind of the binder resin, the additive, the addition amount and the kind of the dispersant, known techniques regarding the magnetic layer are applicable.

[Layer Constitution]

For the constitution of the thickness of the magnetic recording medium used in the invention, a preferred thickness of the non-magnetic support is from 2 to 100 μm and, more preferably, it is from 10 to 80 μm. In a case of providing an undercoat layer between the non-magnetic support and the non-magnetic layer or the magnetic layer, the thickness of the undercoat layer is from 0.01 to 0.8 μm and, preferably, from 0.02 to 0.6 μm.

The thickness of the magnetic layer is optimized in accordance with the amount of saturation magnetization and the head gap length of a magnetic head to be used and the band of the recording signals and it is, generally, from 10 to 100 nm, preferably, from 20 to 80 nm and, more preferably, from 30 to 80 nm. Further, the fluctuation coefficient for the thickness of the magnetic layer is preferably within ±50% and, preferably, within ±40%. At least one magnetic layer may suffice, and the magnetic layer may also be separated into two or more layers having different magnetic characteristics and constitution regarding known stacked magnetic layers is applicable.

The thickness of the non-magnetic layer in the invention is from 0.5 to 2.0 μm and, preferably, from 0.8 to 1.5 μm and, more preferably, from 0.8 to 1.2 μm. The non-magnetic layer of the magnetic recording medium in the invention can provide the effect thereof so long as it is substantially non-magnetic and the effect of the invention is provided also in a case where a small amount of magnetic material etc. is contained as impurity or intentionally and this can be regarded to have substantially identical constitution as the magnetic recording medium of the invention. “Substantially identical” means that the residual magnetic flux density is 10 mT or less or the coercive force is 7.96 kA/m (100 Oe)or less in the non-magnetic layer and it has preferably no residual flux density and coercive force.

[Manufacturing Method]

The step for manufacturing a magnetic layer coating solution for a magnetic recording medium used in the invention includes at least a kneading step, a dispersion step and mixing steps provided optionally before or after the steps. The individual step may be divided respectively into two or more steps. All of the raw materials such as ferromagnetic powder, non-ferromagnetic powder, binder, carbon black, abrasives, antistatics, lubricants and solvent may be added initially or in the course of any step. Further, individual raw materials may be added individually in two or more steps. For example, polyurethane may be charged divisionally in the kneading step, the dispersion step and the mixing step for controlling the viscosity after dispersion. For attaining the purpose of the invention, known manufacturing technique can be used for some of steps. In the kneading step, it is preferred to use those having intense kneading force such as an open kneader, continuous kneader, press kneader, and extruder. Details for the kneading treatment are described in JP-A-1-106338 and JP-A-1-79274. Further, for dispersing a solution for magnetic layer and a solution for non-magnetic layer, glass beads can be used. For the glass beads, zirconia beads, titania beads, and steel beads which are dispersion media of high specific gravity are preferred. The grain size and the packing ratio of the dispersion media are optimized in use. Known dispersion machines can be used.

In the method of manufacturing the magnetic recording medium of the invention, the magnetic layer is coated and formed on the surface of the non-magnetic support under running such that the magnetic coating solution provides a predetermined film thickness. In this case, a plurality of magnetic layer coating solutions may be coated successively or simultaneously as a multi-layered structure, or the coating solution for non-magnetic layer and the coating solution for magnetic layer may be coated successively or simultaneously as stacked coating. The coating machine for coating the magnetic layer coating solution or non-magnetic layer coating solution, air doctor coating, blade coating, rod coating, extrusion coating, air knife coating, squeeze coating, impregnated coating, reverse roll coating, transfer roll coating, gravure coating, kiss coating, cast coating, spray coating, and spin coating can be utilized. “Modern Coating Technique” published from Overall Technical Center (May 31, 1983) can be referred to for them.

The coating layer of the magnetic layer coating solution is applied with a magnetic field orientation treatment for the ferromagnetic powder contained in the coating layer of the magnetic layer coating solution by using a cobalt magnet or solenoid. While isotropic orientation can be obtained sometimes sufficiently under non-orientation without using an orientation device, it is preferred to use a known random orientation device, for example, of orthogonally arranging cobalt magnets alternately or applying alternating magnetic fields by solenoids. For the isotropic orientation, in-plane 2-dimensional random orientation is generally preferred in a case of the ferromagnetic metal powder, a 3-dimensional random orientation can also be obtained by providing a vertical component. In a case of the hexagonal ferrite, it generally tends to take 3-dimensional random orientation within the plane and in the vertical direction, it may apply an in-plane 2-dimensional random orientation. Further, isotropic magnetic characteristic can be provided in the circumferential direction by vertical orientation using a known method such as magnets opposed at different poles. The vertical orientation is preferred particularly in a case of conducting high density recording.

Further, circumferential orientation is also possible by using a spin coating.

It is preferred that the drying position of the coating film can be controlled by controlling the temperature and the blowing amount of a drying blow and the coating speed and it is preferred that the coating speed is from 20 m/min to 1000 m/min and the temperature of the drying blow is 60° C. or higher. Further, an appropriate preliminary drying may also be conducted before entering the magnet zone.

After drying, a surface smoothing treatment is applied usually to the coated layer. For the surface smoothing treatment, a super calender roll is utilized for example. By conducting the surface smoothing treatment, voids formed by the removal of the solvent during drying are eliminated to improve the packing ratio of the ferromagnetic powder in the magnetic layer, a magnetic recording medium of high electromagnetic conversion characteristic can be obtained. As the calendering roll, a heat resistant plastic roll such as made of epoxy, polyimide, polyamide, polyamideimide, etc. is used. Further, the treatment can be applied also by a metal roll.

It is preferred that the surface of the magnetic recording medium of the invention preferably has excellent smoothness that the center average plane roughness on the surface has excellent smoothness within a range from 0.1 to 4 nm, preferably, 1 to 3 nm at the cut-off value of 0.25 mm. The method is applied, for example, by applying a calendering treatment to the magnetic layer formed, for example, by selecting a specified ferromagnetic powder and a binder as described above. For the calendering condition, it is preferably applied at the temperature for the calender roll within a range from 60 to 100° C., preferably, from 70 to 100° C. and, particularly preferably, within a range from 80 to 1000° C. and at a pressure within a range from 100 to 500 kg/cm (98 to 490 kN/m), preferably, within a range from 200 to 450 kg/cm (196 to 441 kN/m), and, particularly preferably, within a range from 300 to 400 kg/cm (294 to 392 kN/m).

The heat shrinkage reducing means includes a method of applying heat treatment in a state of a web while handling under a low tension and a method of applying heat treatment in a state where the tape is laminated such as a state of a bulk or being assembled into a cassette (thermo treating method) and both of them can be utilized. The thermo treating method is preferred with a view point of supplying a magnetic recording medium at high output with no noises.

The obtained magnetic recording medium can be punched out in a punching step by using a known device into a desired size to prepare a flexible disk.

Further, as described above, while it is preferred that the magnetic recording medium of the invention is formed as a flexible disk, it can also be fabricated into a magnetic tape. This makes the slitting property of the magnetic tape favorable during manufacture and the electromagnetic conversion characteristic and reliability are excellent. In a case of forming the magnetic tape, a back layer may also be provided to the rearface of the non-magnetic support (on the side opposite to the surface provided with the magnetic layer). In the back layer coating material, granular ingredients such as abrasives and antistatics and a binder are dispersed in an organic solvent. As the granular ingredient, various kinds of inorganic pigments and carbon black can be used.

Further, for the binder, those resins such as nitrocellulose, phenoxy resin, vinyl chloride resin and polyurethane can be used alone or in admixture. The magnetic recording medium obtained for use in magnetic tape can be cut into a desired size for use by using a cutter or the like. The cutter has no particular restriction and those provided with plural sets of rotating upper blades (male blade), and lower blades (female blade) are preferred and the slit speed, engaging depth, the circumferential speed ratio between the upper blade (male blade) and the lower blade (female blade) (upper blade circumferential speed/lower blade circumferential speed), and the time for continuous use of the slitting blades are selected.

[Physical Characteristic]

Saturation magnetic flux density of the magnetic layer for the magnetic recording medium used in the invention is preferably from 100 to 300 mT. The coercive force (Hr) of the magnetic layer is, preferably, from 143.3 to 318.4 kA/m (1800 to 4000 Oe) and, more preferably, from 159.2 to 278.6 kA/m (2000 to 3500 Oe). Narrower distribution of the coercive force is preferred, and SFD and SDFr are 0.6 or less and, more preferably, 0.2 or less.

The friction coefficient of the magnetic recording medium used in the invention to the head is 0.5 or less and, preferably, 0.3 or less within a temperature range from −10 to 40° C. and a humidity range from 0 to 95%. Further, the surface intrinsic resistance is preferably from 104 to 1012 Ω/sq on the magnetic surface, and the charged potential is preferably from −500 V to +500 V or less. The modulus of elasticity at 0.5% elongation of the magnetic layer is preferably from 0.98 to 19.6 GPa (100 to 2000 kg/mm²) in each of the directions within the plane, the fracture strength is preferably from 98 to 686 MPa (10 to 70 kg/mm², the elasticity of the magnetic recording medium is from 0.98 to 14.7 GPa (100 to 1500 kg/mm²) in each of the directions in the plane, the residual elongation is preferably 0.5% or less, the heat shrinkage rate at any temperature of 100° C. or lower is, preferably, 1% or less, more preferably, 0.5% or less and, most preferably, 0.1% or less.

The glass transition temperature of the magnetic layer (maximal point for the loss of modulus of elasticity in dynamic viscoelastic measurement measured at 110 Hz) is preferably from 50 to 180° C., and that of the non-magnetic layer is preferably from 0 to 180° C. It is preferred that the loss of modulus of elasticity is within a range of 1×10⁷ to 8×10⁸ Pa (from 1×10⁸ to 8×10⁹ dyne/cm²), and the loss tangent is preferably 0.2 or less. In case where the loss tangent is excessively large, adhesion failure tends to occur. It is preferred that the thermal characteristic and the mechanical characteristic are substantially equal being within 10% in each of the directions in the plane.

The residual solvent contained in the magnetic layer is 100 mg/M² or less and, more preferably, 10 mg/M² or less. The void ratio present in the coating layer is, preferably, 30% by volume or less and, more preferably, 20% by volume or less both for the non-magnetic layer and the magnetic layer. While smaller voids ratio is preferred for attaining high output, it may sometimes desired to ensure a certain value depending on the purpose. For example, in a disk medium in which importance is attached to the repetitive use, the running durability is often preferred in a case where the void ratio is larger.

In the magnetic layer, it is preferred that the maximum height of SRmax is 0.5 μm or less, 10-point average roughness of SRz is 0.3 μm or less, the hill height SRp at the central plane is 0.3 μm or less, the valley depth SRv at the central plane is 0.3 μm or less, the central surface area ratio SSr is from 20 to 80%, and the average wavelength Sλa is from 5 to 300 μm. They can be controlled easily by controlling the surface property by the filler of the non-magnetic support and by the roll surface shape by the calender treatment. The curl is preferably with ±3 mm.

In a case of constituting the magnetic recording medium of the invention with a non-magnetic layer and a magnetic layer, the physical properties thereof can be changed for the non-magnetic layer and the magnetic layer in accordance with the purpose. For example, the running durability can be improved by increasing the modulus of elasticity for the magnetic layer and, at the same time, abutment of the magnetic recording medium to the head can be improved by lowering the modulus of elasticity of the non-magnetic layer to lower than that of the magnetic layer.

### EXAMPLES

The present invention is to be described more specifically with reference to examples and comparative examples but the invention is not restricted by the following examples. Further, “parts” in the examples represent mass parts unless otherwise specified particularly.

### Example 1

### Preparation of polyethylene-2,6-naphthalate Film

Pellets of polyethylene-2,6-naphthalate having an intrinsic viscosity of 0.56 dl/g (value measured by using a mixed solvent of phenol/1,1,2,2-tetrachloroethane=60/40 (mass ratio) at 25° C.) containing 0.2 mass % of fine silica particles with an average grain size of 0.1 μm were dried at 170° C. for 4 hours. The polyethylene-2,6-naphthalate was melt extruded at 300° C., and quenched to solidify on a casting drum kept at 60° C. to obtain an unstretched film of about 650 μm thickness. The unstretched film was applied with successive biaxial stretching at a factor of 3.6 in the longitudinal direction at 130° C., and, subsequently, at a factor of 3.7 in the traverse direction at 135° C. then applied with a heat treatment at 230° C. for 30 sec successively. Then, it was cooled at 100° C. for 10 sec and taken-up. In this way, a biaxially oriented polyethylene-2,6-naphthalate film of 50 μm thickness was obtained.

The film had a refractive index of 1.496 dl/g in the direction of the depth, a surface roughness SRa of 5.1 nm, and a Young's modulus of 7.8 GPa both in MD/TD.

Preparation of magnetic coating solution for upper layer

| | |
|---|---|
| Ferromagnetic tabular hexagonal | 100 parts |
| ferrite powder | |
| Composition (molar ratio): | |
| Ba/Fe/Co/Zn = 1/9.1/0.2/0.8, | |
| Hc: 196 kA/m (2450 Oe) | |
| Average tabular diameter: 26 nm | |
| Average tabular ratio: 4 | |
| Specific surface area by BET method: 50 m²/g | |
| σs: 60 A · m²/kg (60 emu/g) | |
| Polyurethane resin | 12 parts |
| branched side chain-containing polyesterpolyol/ | |
| diphenylmethane diisocyanate type | |
| hydrophilic polar group contained: SO₃Na = 70 eq/ton | |
| Phenyl phosphoric acid | 3 parts |
| α-Al₂O₃ (average grain size: 0.15 μm) | 2 parts |
| Carbon black (average grain size: 20 nm) | 2 parts |
| Cyclohexanone | 110 parts |
| Methyl ethyl ketone | 100 parts |
| Toluene | 100 parts |
| Butyl stearate | 2 parts |
| Stearic acid | 1 part |

Preparation of magnetic coating solution for use in lower layer

| | |
|---|---|
| Non-magnetic inorganic power α-iron oxide | 85 parts |
| Surface treatment layer: Al₂O₃, SiO₂ | |
| Average major axial length: 0.15 μm | |
| Tap density: 0.8 | |
| Average acicular ratio: 7 | |
| Specific surface area according to BET method: 52 m²/g | |
| pH: 8 | |
| DBP oil absorption amount: 33 g/100 g | |
| Carbon black | 20 parts |
| DBP oil absorption 120 ml/100 g | |
| pH: 8 | |
| Specific surface area according to BET method: 250 m²/g | |
| Volatile component: 1.5% | |
| Polyurethane resin | 12 parts |
| branched side chain-containing polyesterpolyol/ | |
| diphenylmethane diisocyanate type | |
| hydrophilic polar group contained: —SO₃Na = 70 eq/ton | |
| Acrylic resin | 6 parts |
| benzyl methacrylate/diacetone acrylamide | |
| hydrophilic polar group contained: —SO₃Na = 60 eq/ton | |
| Phenyl phosphoric acid | 3 parts |
| α-Al₂O₃ (average grain size: 0.2 μm) | 1 parts |
| Cyclohexanone | 140 parts |
| Methyl ethyl ketone | 170 parts |
| Butyl stearate | 2 parts |
| Stearic acid | 1 part |

After kneading each of the ingredients for the magnetic coating material for use in the upper layer and a non-magnetic coating material for use in the lower layer respectively in an open kneader for 60 min, they were dispersed in a sand mill for 120 min. 6 parts of a poly-functional low molecular weight polyisocyanate compound (CORONATE 3041, manufactured by Nippon Polyurethane Co.) were added to the obtained liquid dispersion and further stirred and mixed for 20 min. Then, they were filtered by using a filter having an average pore size of 1 μm to prepare a magnetic coating material and a non-magnetic coating material.

Further, the non-magnetic coating material was coated on a support such that the thickness after drying was 1.8 μm and, further, the magnetic coating material was coated immediately thereafter such that the thickness after drying of the coating material was 0.08 μm simultaneously in stack. The non-magnetic coating material and the magnetic coating material were coated on both surfaces of the support.

For the both surfaces of the support, after both of the layers were dried, a surface smoothing treatment was conducted by using a 7-step calender constituted only with metal rolls at a speed of 100 m/min, a line pressure of 294 kN/m (300 kg/cm), and at a temperature of 90° C., and then a heat treatment was applied at 70° C. for 48 hours and it was punched out into 3.7 inch and assembled into a cartridge of ZIP250 manufactured by Fuji Photographic Film Inc. to prepare a flexible disk.

### Examples 2 to 4

The non-magnetic support was changed as shown in Table 1 and flexible disks of Examples 2 to 4 were prepared in the same manner as in Example 1.

### Comparative Examples 1 to 3

The non-magnetic support was changed as shown in Table 1 and flexible disks of Comparative Examples 1 to 3 were prepared in the same manner as in Example 1.

<Measuring and Judging Method>

1. Measurement for Intrinsic Viscosity

A polyester film was dissolved in a mixed solvent of phenol/1,1,2,2-tetrachloroethane=60/40 (mass ratio), and measured by using an automatic viscometer to which a Ubbelohde viscometer at 25° C.

2. Measurement for Refractive Index in the Direction of the Depth

It was measured by using an Abbe's refractometer using sodium D-ray (589 nm) as an optical source and using methylene chloride dissolving sulfur therein as a mount solution at 25° C.

3. Measurement for Stylus Type Three-Dimensional Surface Roughness (SRa) for a Non-Magnetic Support by a Stylus Type Three-Dimensional Surface Roughness Instrument

Each of the surface and the rear face was measured for SRa according to JIS B 0601 (1994) by using a stylus type surface roughness instrument SE3500K manufactured by Kosaka Kenkyusho. The value was identical for both surfaces as shown in Table 1.

4. Measurement for Tensile Characteristic (Young's Modulus) of a Non-Magnetic Support

It was measured in accordance with the method according to JIS K 7113 (1995), by using a STROGRAPH V1-C type tensile tester manufactured by Toyo Seiki under a circumstance at 25° C., 50% RH for a test specimen with a length of 100 mm and a width of 5 mm at a tensile speed of 100 mm/min.

5. Judgement for Punching Property

The end faces of the thus obtained flexible disks were observed microscopically and judged as “◯” for those with no observation of whisker-like punching dusts, as “Δ” for those with observation of whisker-like punching dusts of less than 100 μm and as “×” for those with observation of whisker-like punching dusts of 100 μm or more.

6. Judgement for Durability

Random seeking was conducted by a drive of ZIP 250 under a circumstance at 23° C. and 50% RH and flaws on the media surface were examined 500 hours after. It was judged as “◯” for those with no flaws on the surface of the magnetic layer and as “Δ” for those with flaws being observed and as “×” for those where magnetic layer was dropped under observation with naked eyes and an optical microscope.

TABLE 1

| | Non-magnetic support | | | | | |
|---|---|---|---|---|---|---|
| | | Refractive | | | | |
| | | index | | | | |
| | | in the | | | Result of | |
| | Intrinsic | direction | | Young's | evaluation | |
| | viscosity | of | SRa | modulus | Punching | Dura- |
| | dl/g | depth | nm | GPa | property | bility |
| Example 1 | 0.56 | 1.496 | 5.1 | 7.8 | ◯ | ◯ |
| Example 2 | 0.56 | 1.491 | 5.1 | 8.0 | Δ | ◯ |
| Example 3 | 0.53 | 1.496 | 5.1 | 7.8 | ◯ | ◯ |
| Example 4 | 0.48 | 1.496 | 5.1 | 7.8 | ◯ | ◯ |
| Comp. | 0.60 | 1.496 | 5.1 | 8.0 | Δ | Δ |
| Example 1 | | | | | | |
| Comp. | 0.45 | 1.496 | 5.1 | 8.0 | Δ | Δ |
| Example 2 | | | | | | |
| Comp. | 0.60 | 1.488 | 5.1 | 8.2 | X | X |
| Example 3 | | | | | | |

It can be seen from Table 1 that while flexible disks having a non-magnetic substrate in which the intrinsic viscosity and the refractive index in the direction of the depth can satisfy the range specified according to the invention are at a level capable of satisfying both the punching property and the durability, but comparative examples not satisfying one or both of the intrinsic viscosity and the refractive index in the direction of the depth provided a result being deteriorated both for the punching property and the durability.

This application is based on Japanese Patent application JP 2004-301500, filed Oct. 15, 2004, the entire content of which is hereby incorporated by reference, the same as if set forth at length.

What is claimed is:

1. A magnetic recording medium comprising a non-magnetic support and at least one magnetic layer containing a ferromagnetic powder and a binder, wherein the non-magnetic support has an intrinsic viscosity of from 0.46 to 0.58 dl/g and a refractive index in a direction of a depth within a range from 1.490 to 1.500.

2. The magnetic recording medium according to claim 1, wherein the ferromagnetic powder is a ferromagnetic hexagonal ferrite powder having an average tabular diameter of from 5 to 40 nm.

3. The magnetic recording medium according to claim 1, wherein the non-magnetic support has an intrinsic viscosity of from 0.47 to 0.57 dl/g.

4. The magnetic recording medium according to claim 1, wherein the non-magnetic support has an intrinsic viscosity of from 0.48 to 0.56 dl/g.

5. The magnetic recording medium according to claim 1, wherein the non-magnetic support has a refractive index in a direction of a depth within a range from 1.491 to 1.499.

6. The magnetic recording medium according to claim 1, wherein the non-magnetic support has a refractive index in a direction of a depth within a range from 1.492 to 1.498.

7. The magnetic recording medium according to claim 1, wherein the non-magnetic support has Young's modulus in a longitudinal direction of from 6.0 to 9.0 GPa and has Young's modulus in a traverse direction of from 6.0 to 9.0 Gpa.

8. The magnetic recording medium according to claim 1, wherein the non-magnetic support has Young's modulus in a longitudinal direction of from 6.2 to 8.8 GPa and has Young's modulus in a traverse direction of from 6.2 to 8.8 Gpa.

9. The magnetic recording medium according to claim 1, wherein the non-magnetic support has a stylus type, three-dimensional mean surface roughness SRa of from 1.0 to 8.0 nm.

10. The magnetic recording medium according to claim 1, wherein the non-magnetic support has a stylus type, three-dimensional mean surface roughness SRa of from 1.5 to 6.0 nm.

11. The magnetic recording medium according to claim 1, wherein the non-magnetic support comprises one of biaxially stretched polyethylene naphthalate, biaxially stretched polyethylene terephthalate, biaxially stretched polyamide, biaxially stretched polyimide, biaxially stretched polyamideimide, biaxially stretched aromatic polyamide, and biaxially stretched polybenzoxazole.

12. The magnetic recording medium according to claim 1, wherein the non-magnetic support comprises one of biaxially stretched polyethylene terephthalate and biaxially stretched polyethylene naphthalate.

13. The magnetic recording medium according to claim 1, wherein the non-magnetic support has a thickness of from 2 to 100 μm.

14. The magnetic recording medium according to claim 1, wherein the non-magnetic support has a thickness of from 10 to 80 μm.

15. The magnetic recording medium according to claim 1, further comprising a non-magnetic layer between the non-magnetic support and the at least one magnetic layer, the non-magnetic layer containing a binder and a non-magnetic powder.
